(19) United States
(12) Patent Application Publication
(10) Pub. No.: US 2024/0083261 A1
(43) Pub. Date: Mar. 14, 2024

(54) MOTOR POWER RATIO FOR ELECTRIC VEHICLE

(71) Applicant: Schaeffler Technologies AG & Co. KG, Herzogenaurach (DE)

(72) Inventors: Patrick Lindemann, Wooster (DE); Ryan Cooper, Wooster, OH (US); Markus Steinberger, Sagamore Hills, OH (US)

(73) Assignee: Schaeffler Techologies AG & Co. KG, Herzogenaurach (DE)

(21) Appl. No.: 18/125,329

(22) Filed: Mar. 23, 2023

Related U.S. Application Data
(60) Provisional application No. 63/404,423, filed on Sep. 7, 2022.

(51) Int. Cl. B60L 15/20; H02K 21/46

(52) U.S. Cl. CPC B60L 15/2045; H02K 21/46; B60L 2220/12; B60L 2220/14

(57) ABSTRACT

A drive system for an electric vehicle includes a primary motor with a first power and a secondary motor with a second power, greater than the first power. The primary motor may be a synchronous motor and the secondary motor may be an asynchronous motor. The primary motor may be a permanent magnet motor and the secondary motor may be an induction motor. A power ratio between the first power of the primary motor and the second power of the secondary motor may be less than 1.

### CROSS REFERENCE TO RELATED APPLICATION(S)

This application claims the benefit of U.S. Provisional Application 63/404,423, filed Sep. 7, 2022 and titled “Motor Power Ratio for Electric Vehicle”, which is incorporated by reference as if fully set forth.

### FIELD OF INVENTION

The present disclosure relates generally to power ratios in motor vehicles, and more specifically to a motor power ratio for an electric vehicle.

### BACKGROUND

A controller configured to vary respective magnitudes of rotary power provided by electric motors to satisfy a torque request in a manner that maximizes a combined efficiency of the motors is known from U.S. Pat. No. 11,186,181, titled “DRIVE SYSTEM AND METHOD FOR VEHICLE EMPLOYING MULTIPLE ELECTRONIC MOTORS” to Ronning et al.

A permanent magnet motor is a synchronous motor that uses permanent magnets embedded in a ferrite rotor to create a constant magnetic field. A stator carries windings connected to an alternating current (AC) supply from a power electronics unit, for example, to produce a rotating magnetic field. At steady state, rotation of the rotor is synchronized with a frequency of the supply current.

An induction motor is an asynchronous motor in which an electric current in a rotor needed to produce torque is electromagnetically induced from a magnetic field of a stator winding. For rotor currents to be induced, the speed of the physical rotor must be lower than that of the stator's rotating magnetic field.

Both types of motors have advantages and disadvantages. For example, a permanent magnet motor is more efficient at certain operating conditions than an induction motor. It is for this reason that many available electric vehicles use a permanent magnet motor as a main power source. But the constant magnetic field of a permanent magnet motor produces a negative torque (e.g., by generating electricity) when not under power (i.e. when the permanent magnet motor spins without electrical energy being provided to the motor). An induction motor has fewer losses when not under power because the magnetic field is not generated when the rotor is not electromagnetically induced by the stator. Therefore, most of the unpowered loss in an induction motor comes from windage and parasitic friction loss from bearings. This is why induction motors are often selected for use as a secondary motor in an electric vehicle.

As discussed above, currently available electric vehicles generally use a permanent magnet motor as a main power source due to its higher efficiency. Operating as a primary drive, the permanent magnet motors are sized to perform everyday driving of the electric vehicle. A secondary power source (secondary motor) is used in some electric vehicles for improved acceleration (e.g., sports cars) or off-road capability (e.g., trucks and SUVs). In many electric vehicles, during normal driving, the secondary motor may be used only sparingly.

During normal driving, however, the previous permanent magnet motors may not be operating at peak efficiency. For example, during highway cruising, an electric vehicle power requirement may be much less than when accelerating from a stop. Therefore, a primary power source (primary motor) sized to provide drivability (e.g., acceptable acceleration) may be oversized for highway cruising and the primary motor may be operating at a lower than desired efficiency.

Currently the electric axles (e-axles) of electric vehicles are configured similar to an internal combustion engine drivetrain where the primary drive axle mostly propels the vehicle and the weaker secondary axle helps where needed. But this is inefficient when used for e-axles, because, if the primary motor is sized as the main power source of the vehicle, it will be operating most of the time in a low power area where it is not as efficient. Therefore, in previous electric axle configurations, a power ratio between a primary drive power and a secondary drive power is greater than one.

As seen from the above, there is a need for a more efficient electric axle configuration for electric vehicles.

### SUMMARY

According to one embodiment, a drive system for an electric vehicle may include a primary motor with a first power and a secondary motor with a second power, greater than the first power. The primary motor may be a synchronous motor and the secondary motor may be an asynchronous motor. The primary motor may be a permanent magnet motor and the secondary motor may be an induction motor. A power ratio between the first power and the second power may be less than 1.

The first power may be selected such that the primary motor operates at an average efficiency of at least ninety-four percent (94%) during vehicle testing. The first power may be selected such that an overall vehicle average efficiency during vehicle testing is at least ninety-three percent (93%).

The first power may be selected such that the primary motor operates at an average efficiency of at least ninety-four percent (94%) during vehicle testing. The first power may be selected such that an overall vehicle average efficiency during vehicle testing is at least at least ninety point five percent (90.5%).

According to another embodiment, a drive system for an electric vehicle includes a primary, synchronous permanent magnet motor with a first power specification and a secondary, asynchronous induction motor with a second power specification. A power ratio between the first power specification and the second power specification may be less than 1. The power ratio may be between 0.33 and 0.6.

According to another embodiment, a drive system is disclosed for a motor vehicle. The drive system can include a primary axle including a primary motor rotationally coupled to a first differential of the primary axle, the primary motor comprising a first power. A secondary axle including a secondary motor rotationally coupled to a second differential of the secondary axle, the secondary motor comprising a second power greater than the first power. A power electronics unit can be electrically coupled to the primary motor and the secondary motor. The power electronics unit can transmit power to the primary motor and the secondary motor.

In one embodiment, the motor vehicle is an electric vehicle.

In one embodiment, the primary axle is configured to propel the motor vehicle in a desired direction during a normal driving cycle, and the secondary axle is inactive during the normal driving cycle, and wherein the normal driving cycle includes maintaining a generally constant motor vehicle speed.

In one embodiment, the primary motor is a synchronous motor, and the secondary motor is an asynchronous motor.

In one embodiment, the primary motor is a permanent magnet motor, and the secondary motor is an induction motor.

In one embodiment, the power transmitted by the power electronics unit is voltage and current.

In one embodiment, the power electronics unit receives incoming power from a battery, a fuel cell stack, a solar panel, or generator.

In one embodiment, a power ratio between the first power and the second power is less than one.

In one embodiment, the power ratio is between 0.33 and 0.6.

### BRIEF DESCRIPTION OF THE DRAWING(S)

The foregoing Summary as well as the following Detailed Description will be best understood when read in conjunction with the appended drawings, which illustrate a preferred embodiment according to the disclosure. In the drawings:

FIG. 1 illustrates a schematic view of a drive system for an electric vehicle.

FIG. 2A illustrates a first portion of a motor efficiency diagram for a permanent magnet motor at different speeds and torques.

FIG. 2B illustrates a second portion of the motor efficiency diagram for a permanent magnet motor at different speeds and torques.

FIG. 3 illustrates a graph of vehicle speed plotted against time for a United States Environmental Protection Agency Highway Fuel Economy Driving Schedule (HWFET).

FIG. 4 illustrates a graph of vehicle efficiency plotted against a permanent magnet motor power for a 120 kW drive system for a mid-size electric vehicle during the United States Environmental Protection Agency Highway Fuel Economy Driving Schedule (HWFET).

FIG. 5 illustrates a graph of vehicle speed plotted against time for a Worldwide harmonized Light vehicles Test Procedures (WLTP).

FIG. 6 illustrates a graph of vehicle efficiency plotted against a permanent magnet motor power for a 120 kW drive system for a mid-size electric vehicle during the Worldwide harmonized Light vehicles Test Procedures (WLTP).

FIG. 7 illustrates a comparison of vehicle speed plotted against time for the United States Environmental Protection Agency Highway Fuel Economy Driving Schedule (HWFET) and the Worldwide harmonized Light vehicles Test Procedures (WLTP).

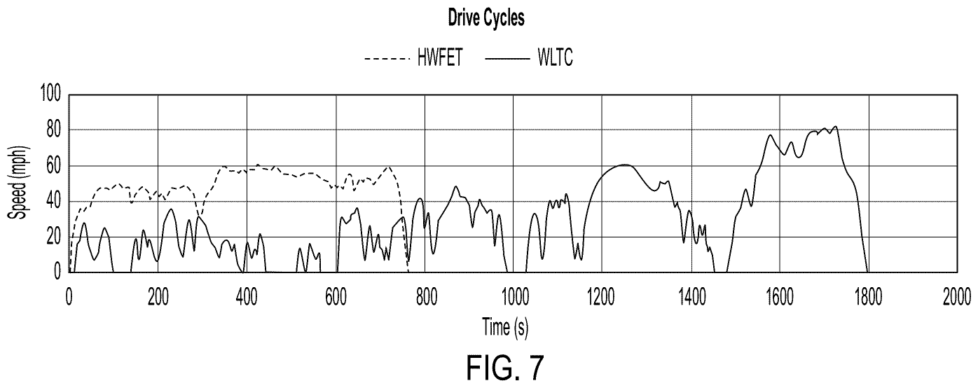

FIG. 8 illustrates a comparison of vehicle efficiency plotted against a permanent magnet motor power for a 120 kW drive system for a mid-size electric vehicle during the United States Environmental Protection Agency Highway Fuel Economy Driving Schedule (HWFET) and the Worldwide harmonized Light vehicles Test Procedures (WLTP).

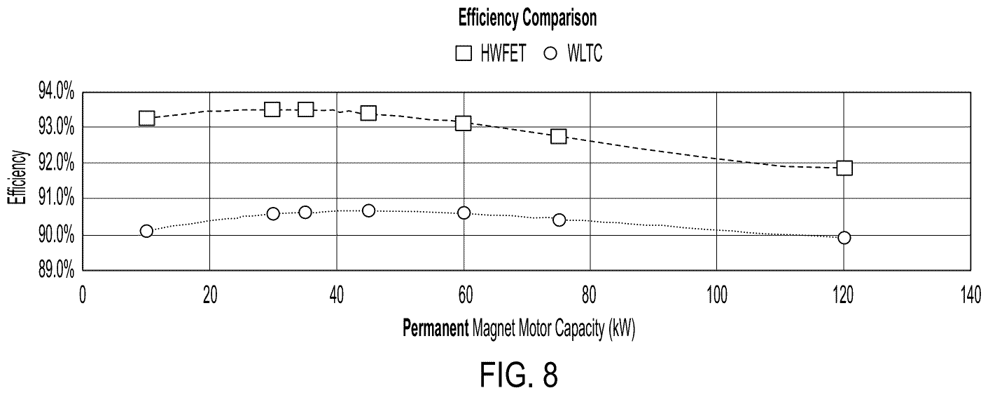

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

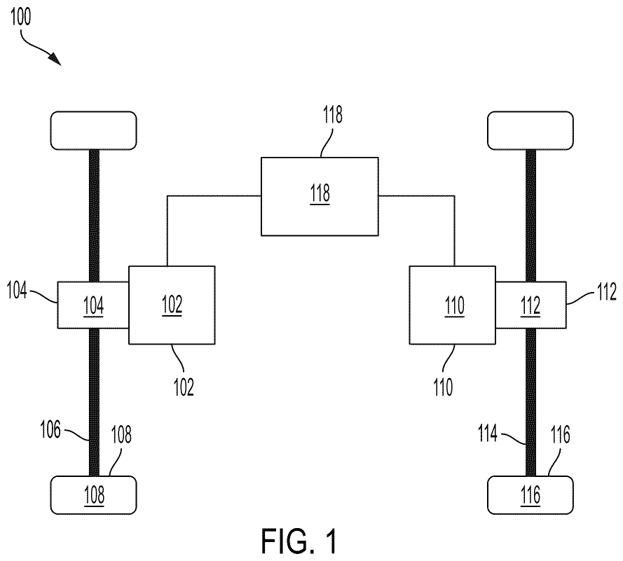

FIG. 1 illustrates a schematic view of a drive system 100 for an electric vehicle (not shown). The drive system 100 includes a primary motor 102 rotationally connected to a first differential 104 which is, in turn, rotationally connected to a first axle 106 (shown with two axle shafts) and first wheels 108. Similarly, the drive system 100 can also include a secondary motor 110 rotationally connected to a second differential 112 which is, in turn, rotationally connected to a second axle 114 (also shown with two axle shafts) and second wheels 116. The electric vehicle may be oriented such that the first wheels 108 are front wheels and the second wheels 116 are rear wheels, or vice versa. A power electronics unit 118 transmits voltage and current (i.e., power/electrical power) to the primary motor 102 and the secondary motor 110 as required to propel the electric vehicle in a desired direction. The power electronics unit 118 may receive incoming power from a battery, fuel cell stack, solar panel, generator, or any other energy source.

The primary motor 102 includes a first power and the secondary motor 110 includes a second power, with the second power being greater than the first power. In other words, the motors 102, 110 are designed with sufficient componentry to provide a specified power to propel the electric vehicle when commanded by the power electronics unit 118. Motor componentry may include diameter of a rotor and stator; wire diameter, length, and/or number of turns in a stator and/or rotor; mass of a ferrite rotor; quantity, size and/or number of permanent magnets; or other design criterion known in the art.

In one embodiment, the primary motor 102 can be a synchronous motor and the secondary motor 110 can be an asynchronous motor. In some embodiments, the primary motor 102 can be a permanent magnet motor and the secondary motor 110 can be an induction motor. As will be described in more detail below, it has been determined that a desirable electric vehicle efficiency is achieved when a power ratio between the first power of the primary motor 102 and the second power of the secondary motor 110 is less than 1. The specific or exact power ratio between the first power and the second power is vehicle dependent, based on the size and weight of the electric vehicle, among other factors.

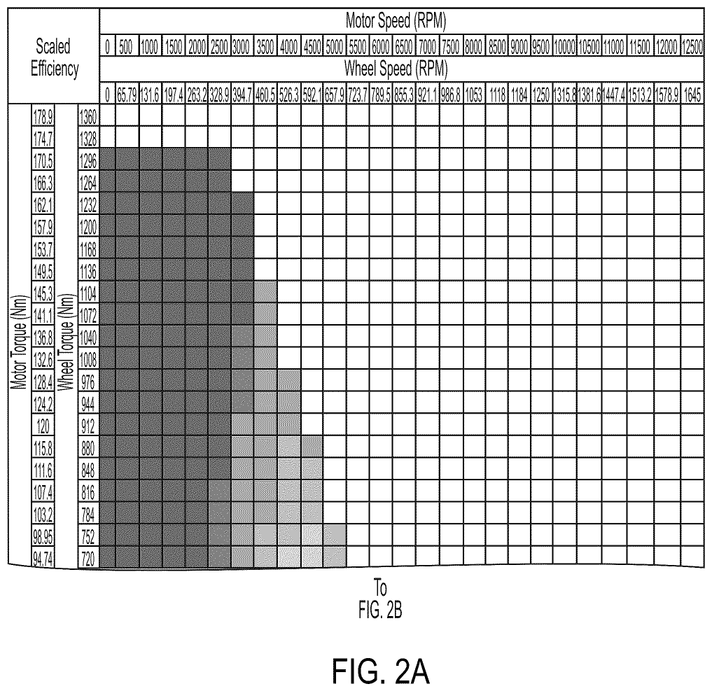

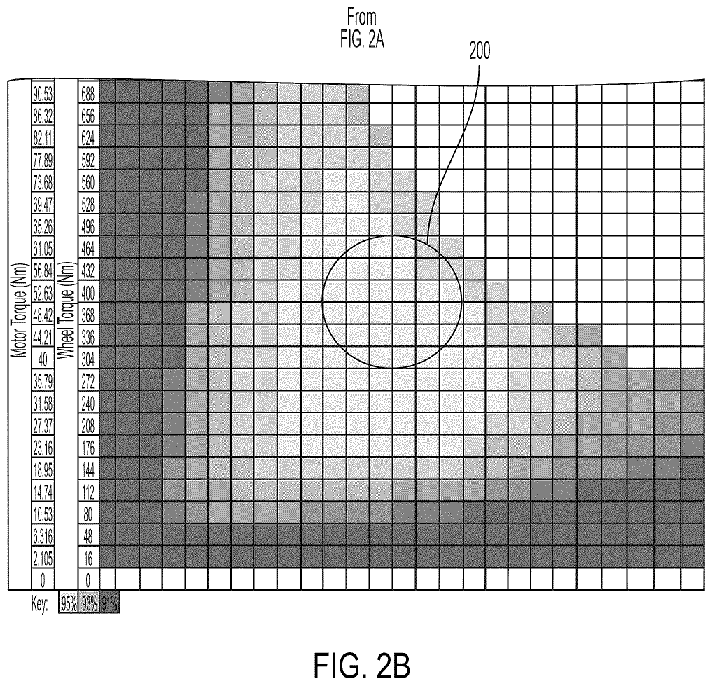

FIGS. 2A-2B illustrate a motor efficiency diagram for a permanent magnet motor, such as the primary motor 102, at different speeds and torques. As illustrated in FIGS. 2A-2B, the darker/darkest gray areas represent operating conditions of the primary motor 102 with lower efficiency, and the lighter/lightest gray areas represent operating conditions of the primary motor 102 with higher efficiency. Further, as illustrated in FIGS. 2A-2B, the areas of the diagram that transition between the darker/darkest gray areas and the lighter/lightest gray areas represent operating conditions of the primary motor 102 that are somewhere between high and low operating efficiency. As will be discussed below, it is desirable for the primary motor 102 to operate within the areas of FIGS. 2A-2B that are shaded with the lighter/lightest gray areas, which represent operating conditions of the primary motor 102 with high efficiency.

A circled area 200 in FIG. 2B indicates a desirable operating point for the primary motor 102 due to its high efficiency, but a conventionally designed electric powertrain often operates at a lower power where the motor is less efficient (the darker/darkest gray areas). This is because conventional electric drivetrain designs use a previous primary motor with sufficient power to operate the electric vehicle solely during most events (accelerating, highway driving, uphill driving, etc.). In other words, if the previous primary motor is sized to fulfill most or all of the vehicle requirements most of the time while it was on the highway (where it will spend most of its time), it would normally exert less torque and operate in the region below the circled area 200, illustrated in FIG. 2B. For example, the previous primary motor may be sized to provide sufficient acceleration torque for an average driver and the previous secondary motor may only be energized during high acceleration or slip (e.g., mud or snow) conditions. Further, the secondary motor can be energized anytime that all wheel drive is required.

As such, in previous (conventional) electric drivetrains the primary drive is sized to meet more than the average drive cycle requirements, such as high acceleration events, which results in the previous electric drivetrains being inefficient. The present drivetrain 100 addresses the previous issues by sizing the primary motor 102 to fulfill the “normal” drive cycles, which is steady highway driving. During normal drive cycles (steady highway driving), the primary motor 102 is sized to fulfill the power requirements of the electric vehicle and the secondary motor 110 is not utilized. Then during other events, such as acceleration, uphill driving, off-road driving, heaving towing, etc., the secondary motor 110 is utilized to fulfill the additional power requirements of the electric vehicle.

Therefore, in the present design, the primary motor 102 has a lower motor power and it normally operates at a higher torque, closer to its maximum power and the desirable operating point, compared to the previous primary motor in conventional electric drivetrain designs. When more torque is desired, the secondary motor 110, with its larger power, supplements the primary motor 102 to achieve the drivability targets for the electric vehicle. As discussed above, although less efficient than the primary motor 102, the secondary motor 110 has lower losses when it is not being used and is no longer energized, for example once the additional acceleration is no longer required. This results in a drivetrain that is overall more efficient than previous electric drivetrains, as described below.

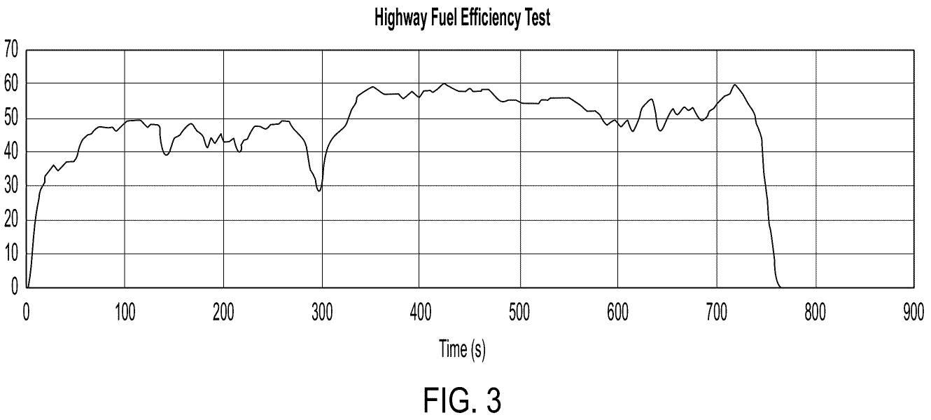

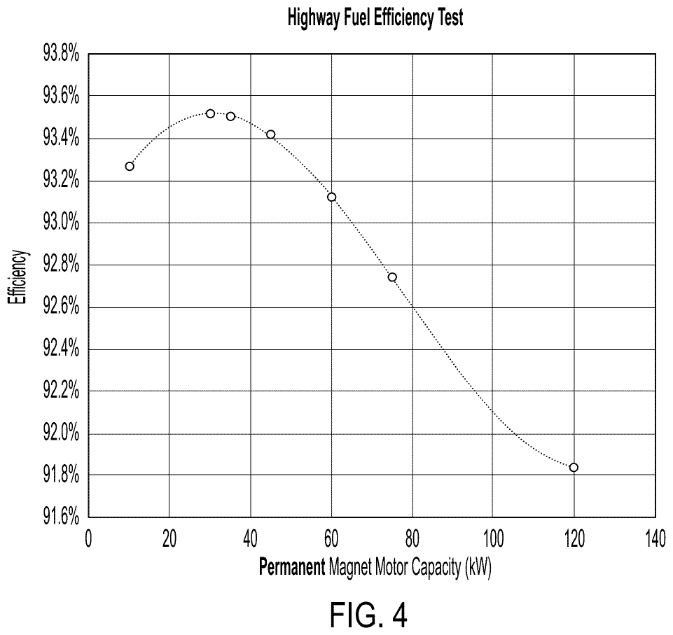

FIG. 3 illustrates a graph of an electric vehicle speed plotted against time for a test cycle conducted using the United States Environmental Protection Agency Highway Fuel Economy Driving Schedule (HWFET), as established in 40 CFR 600.001-600.514 and accessed in July 2022. The Highway Fuel Economy Driving Schedule is available on the United States EPA website at: https://www.epa.gov/vehicle-and-fuel-emissions-testing/dynamometer-drive-schedules. FIG. 4 illustrates a graph of an electric vehicle efficiency plotted against a permanent magnet motor power for a 120 kW drive system for a mid-size electric vehicle during a test cycle conducted using the United States Environmental Protection Agency Highway Fuel Economy Driving Schedule (HWFET), as established in 40 CFR 600.001-600.514 and accessed in July 2022.

As illustrated in FIG. 3, during the test cycle the electric vehicle speed is generally maintained between 30 miles per hour and 60 miles per hour over a time period of about 775 seconds, and there are few large acceleration events. As shown in FIG. 4 and Table 1 below, the overall vehicle efficiency is lowest when the primary motor 102 provides all of the required 120 kW vehicle power, and the overall vehicle efficiency is highest when the primary motor 102 power is about 30 kW, corresponding to a power ratio between the primary motor 102 and the secondary motor 110 of: Power ratio=Primary motor power/Secondary motor power=30 kW/90 kW=0.33.

TABLE 1
Simulated results for mid-size electric vehicle during HWFET

| Motor kW | Losses | Energy used | |
|---|---|---|---|
| (Pri-Sec) | (kWh) | (kWh) | Efficiency |
| 120-0 | 0.211 | 2.580 | 91.74% |
| 75-45 | 0.185 | 2.555 | 92.75% |
| 60-60 | 0.175 | 2.545 | 93.12% |
| 45-75 | 0.167 | 2.537 | 93.42% |
| 35-85 | 0.165 | 2.534 | 93.50% |
| 30-90 | 0.164 | 2.534 | 93.52% |
| 10-110 | 0.171 | 2.541 | 93.27% |

The improved efficiency at a power ratio of 0.33 is at least partially because the primary motor 102 operates near the desirable operating point described above at an average efficiency of at least ninety-four percent (94%) during vehicle testing using the United States Environmental Protection Agency Highway Fuel Economy Driving Schedule (HWFET), as established in 40 CFR 600.001-600.514 and accessed in July 2022. As shown in Table 1, when the first power of the primary motor 102 is equal to or less than the second power of the secondary motor 110, the overall average vehicle efficiency during vehicle testing using the United States Environmental Protection Agency Highway Fuel Economy Driving Schedule (HWFET), as established in 40 CFR 600.001-600.514 and accessed in July 2022, is at least ninety-three percent (93%). Simulating the primary motor 102 in a drive cycle provides the advantage of finding the optimum power of the primary motor 102 that result in the best efficiency of the electric vehicle. As such, increasing or decreasing the size of the motor will not improve the efficiency of the electric vehicle as the optimum/desired power of the primary motor 102 has been strategically selected.

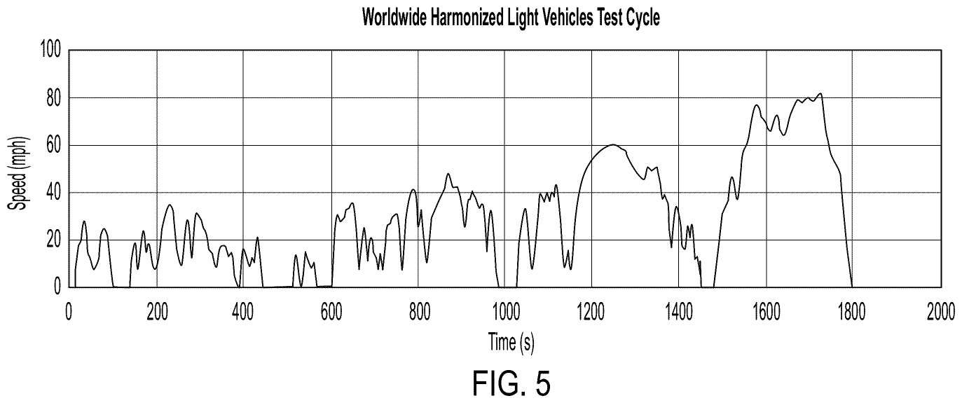

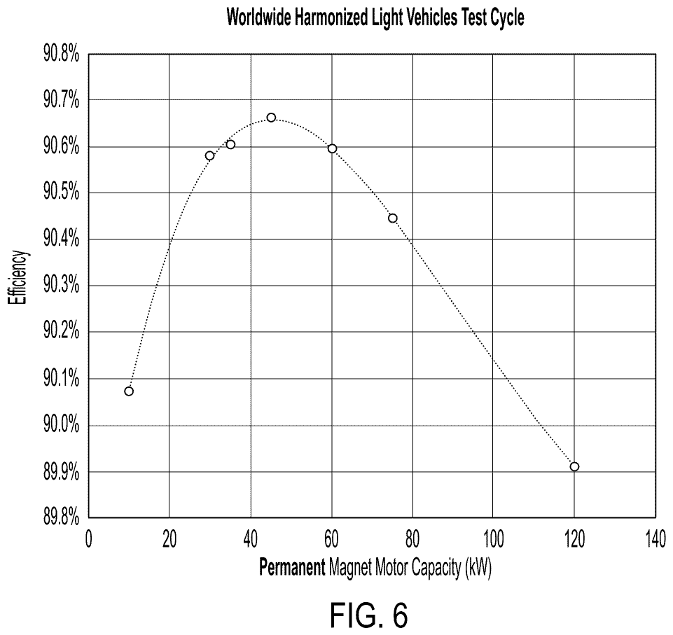

FIG. 5 illustrates a graph of an electric vehicle speed plotted against time for a test cycle conducted using the Worldwide harmonized Light vehicles Test Procedures (WLTP), which was accessed in July 2022. The Worldwide harmonized Light vehicles Test Procedure is available on the United Nations Economic Commission for Europe (UNECE) website at: https://unece.org/transport/documents/2021/01/standards/addendum-15-united-nations-global-technical-regulation-no-15. FIG. 6 illustrates a graph of electric vehicle efficiency plotted against a permanent magnet motor power for a 120 kW drive system for a mid-size electric vehicle during a test cycle conducted using the Worldwide harmonized Light vehicles Test Procedures (WLTP), which was accessed in July 2022.

As illustrated in FIG. 5, the electric vehicle speed varies between 0 miles per hour and 80 miles per hour over a time period of about 1800 seconds, and there are several large acceleration events. As shown in FIG. 6 and Table 2 below, overall electric vehicle efficiency is lowest when the primary motor 102 provides all of the required 120 kW vehicle power, and highest when the primary motor 102 power is about 45 kW corresponding to a power ratio between the primary motor 102 and the secondary motor 110 of:

TABLE 2
Simulated results for mid-size electric vehicle during WLTP
Power ratio = Primary motor power/Secondary
motor power = 45 kW/75 kW = 0.6.

| Motor kW | Losses | Energy used | |
|---|---|---|---|
| (Pri-Sec) | (kWh) | (kWh) | Efficiency |
| 120-0 | 0.375 | 3.717 | 89.91% |
| 75-45 | 0.353 | 3.695 | 90.45% |
| 60-60 | 0.347 | 3.689 | 90.60% |
| 45-75 | 0.344 | 3.686 | 90.66% |
| 35-85 | 0.346 | 3.688 | 90.61% |
| 30-90 | 0.348 | 3.689 | 90.58% |
| 10-110 | 0.368 | 3.710 | 90.07% |

The improved efficiency at a power ratio of 0.6 is at least partially because the primary motor 102 operates near the desirable operating point described above at an average efficiency of at least ninety-four percent (94%) during vehicle testing using the Worldwide harmonized Light vehicles Test Procedures (WLTP) as established by Addendum 15: United Nations Global Technical Regulation No. 15 (accessed in July 2022). As shown in Table 2, when the first power of the primary motor 102 is between one third (⅓) and equal to the second power of the secondary motor 110, the overall vehicle average efficiency during vehicle testing using the Worldwide harmonized Light vehicles Test Procedures (WLTP) as established by Addendum 15: United Nations Global Technical Regulation No. 15 (accessed in July 2022) is at least ninety point five percent (90.5%).

Thus, the present disclosure provides a drive system 100 for an electric vehicle including a primary motor 102 (which in some examples is a synchronous permanent magnet motor) comprising a first power specification and a secondary motor 110 (which in some examples is an asynchronous induction motor) comprising a second power specification. In some exemplary embodiments, a power ratio between the first power specification and the second power specification is less than 1. Further, for the illustrated examples, improved efficiency of the electric vehicle is achieved when the power ratio is between one third (0.33) and six tenths (0.6). Therefore, in some examples, an optimum power ratio for an example mid-size vehicle is between 0.4-0.5. In other examples, the optimum power ratio may be greater or less than the power ratio range of 0.4-0.5, depending on the size and weight of the electric vehicle, among other factors. But in each example, the power ratio between the first power specification and the second power specification is less than 1.

The proposed electric drivetrain uses a weaker drive for the primary axle powered by the primary motor 102 (which in some examples is a permanent magnet motor) and a stronger drive for the secondary axle powered by the secondary motor 110 (which in some examples is an induction motor) to meet demands and requirements of the electric vehicle during all operating conditions. The primary drive is sized to be most efficient in the electric vehicle's primary use case (i.e., highway driving), and the secondary drive is used to allow the electric vehicle to fulfill its remaining requirements (i.e., acceleration, hill climbs, etc.). When the electric vehicle is in its primary use case, the secondary motor 110 can be turned off, minimizing energy losses of the electric vehicle.

During operation of the electric vehicle, the primary axle is active during all points where the electric vehicle is required to apply torque to the road. Further, the primary axle including the primary motor 102 is sized to operate in its most efficient region during its intended use (e.g., cruising on the highway). This will most likely mean that it will not fulfill all of the electric vehicle requirements (e.g., 0 to 60 mph times and/or hill climbs). In cases where the primary axle including the primary motor 102 is not sufficient, the secondary axle including the secondary motor 110 is engaged to allow the electric vehicle to fulfill the extra requirements and/or demands on the electric vehicle. When the primary motor 102 is powerful enough to power the electric vehicle, the secondary motor 110 is shut off, eliminating most of the secondary motor 110 energy losses.

It should be noted that the above simulations were performed for a mid-size vehicle. Other vehicles (e.g., sports cars or large SUVs) may be designed for a higher vehicle power. In these cases, the power ratio may be even lower as the primary motor 102 power is sized similarly for normal driving cycles and the secondary motor 110 power is further increased for added performance and/or towing. In addition, smaller vehicles (e.g., compact cars) may have a lower secondary motor 110 power that would shift the power ratio slightly higher, but never greater than 1.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LOG OF REFERENCE NUMERALS

100 Drive System
102 Primary Motor
104 First Differential
106 First Axle
108 First Wheels
110 Secondary Motor
112 Second Differential
114 Second Axle
116 Second Wheels
200 Circled Area

What is claimed is:

1. A drive system for an electric vehicle, the drive system comprising:
a primary motor comprising a first power; and
a secondary motor comprising a second power, the second power being greater than the first power.

2. The drive system of claim 1, wherein:
the primary motor is a synchronous motor; and
the secondary motor is an asynchronous motor.

3. The drive system of claim 1, wherein:
the primary motor is a permanent magnet motor; and
the secondary motor is an induction motor.

4. The drive system of claim 1, wherein a power ratio between the first power and the second power is less than 1.

5. The drive system of claim 1, wherein the first power is selected such that the primary motor operates at an average efficiency of at least ninety-four percent (94%) during vehicle testing.

6. The drive system of claim 5, wherein the first power is selected such that an overall vehicle average efficiency during vehicle testing is at least ninety-three percent (93%).

7. The drive system of claim 1, wherein the first power is selected such that the primary motor operates at an average efficiency of at least ninety-four percent (94%) during vehicle testing.

8. The drive system of claim 7, wherein the first power is selected such that an overall vehicle average efficiency during vehicle testing is at least ninety point five percent (90.5%).

9. The drive system of claim 1, wherein a power ratio between the first power and the second power is between 0.33 and 0.6.

10. A drive system for a motor vehicle, the drive system comprising:
a primary axle including a primary motor rotationally coupled to a first differential of the primary axle, the primary motor comprising a first power;
a secondary axle including a secondary motor rotationally coupled to a second differential of the secondary axle, the secondary motor comprising a second power greater than the first power; and
a power electronics unit electrically coupled to the primary motor and the secondary motor, wherein the power electronics unit transmits power to the primary motor and the secondary motor.

11. The drive system of claim 10, wherein the motor vehicle is an electric vehicle.

12. The drive system of claim 10, wherein the primary axle is configured to propel the motor vehicle in a desired direction during a normal driving cycle, and the secondary axle is inactive during the normal driving cycle, and the normal driving cycle includes maintaining a generally constant motor vehicle speed.

13. The drive system of claim 10, wherein the primary motor is a synchronous motor, and the secondary motor is an asynchronous motor.

14. The drive system of claim 10, wherein the primary motor is a permanent magnet motor, and the secondary motor is an induction motor.

15. The drive system of claim 10, wherein the power transmitted by the power electronics unit is voltage and current.

16. The drive system of claim 15, wherein the power electronics unit receives incoming power from a battery, a fuel cell stack, a solar panel, or generator.

17. The drive system of claim 10, wherein a power ratio between the first power and the second power is less than one.

18. The drive system of claim 17, wherein the power ratio is between 0.33 and 0.6.

19. A drive system for an electric vehicle, the drive system comprising:
a primary, synchronous permanent magnet motor comprising a first power specification; and
a secondary, asynchronous induction motor comprising a second power specification, wherein a power ratio between the first power specification and the second power specification is less than 1.

20. The drive system of claim 19, wherein the power ratio is between 0.33 and 0.6.
